(19) United States
(12) Patent Application Publication
(10) Pub. No.: US 2014/0119056 A1
(43) Pub. Date: May 1, 2014

(54) Light Guide Plate and Backlight Module Using the Light Guide Plate

(71) Applicant: SHENZHEN CHINA STAR OPTOELECTRONICS TECHNOLOGY CO., LTD., Shenzhen City, Guangdong Province (CN)

(72) Inventors: Kuangyao Chang, Shenzhen City (CN); Chong Xiong, Shenzhen City (CN)

(73) Assignee: Shenzhen China Star Optoelectronics Technology Co., LTD., Shenzhen City, Guangdong Provice (CN)

(21) Appl. No.: 13/806,769

(22) PCT Filed: Nov. 8, 2012
(86) PCT No.: PCT/CN2012/084261

§ 371 Date: Dec. 22, 2012

(30) Foreign Application Priority Data
Oct. 31, 2012 (CN) 201210428334.X

(51) Int. Cl. F21V 8/00

(52) U.S. Cl. CPC G02B 6/0036; G02B 6/0085
USPC 362/625

(57) ABSTRACT

The present invention provides a light guide plate and a backlight module using the light guide plate. The light guide plate includes a bottom surface, a top surface arranged opposite to the bottom surface, and a plurality of lateral surfaces arranged between the bottom surface and the top surface. One of the lateral surfaces forms a light incidence surface. The bottom surface forms a plurality of grid dots having a cross-section that is right angular. The grid dots are formed by recessing the bottom surface of the light guide plate toward the top surface. The grid dots each have an inclined face opposing the light incidence surface. The inclined face is arranged to get away from the light incidence surface by extending upward from the bottom surface. Light entering the light guide plate is reflected by the grid dots to emerge through an emerging surface of the light guide plate.

### BACKGROUND OF THE INVENTION

1. Field of the Invention

The present invention relates to the field of liquid crystal displaying, and in particular to a light guide plate and a backlight module using the light guide plate.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel pieces of glass and a plurality of vertical and horizontal fine electrical wires is arranged between the two pieces of glass, whereby the liquid crystal molecules are controlled to change direction by application of electricity in order to refract out light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the back side of the liquid crystal panel to form a planar light source that directly provides lighting to the liquid crystal panel. The side-edge backlight module comprises a backlighting source of an LED light bar arranged at an edge of a backplane that is located rearward of one side of the liquid crystal panel. The LED light bar emits light that enters a light guide plate (LGP) through a light incident face of the light guide plate and is projected out through a light emergence face of the light guide plate, after being reflected and diffused, to thereby form a planar light source for the liquid crystal panel.

To improve homogeneity of illumination and light intensity, a general way is to provide grid dots on a bottom surface of the light guide plate. These grid dots function to change the propagation direction of light. The conventional ways of manufacturing the grid dots include ink printing, mechanical engraving, chemical etching, and injection molding.

As shown in FIGS. 1 and 2, a conventional light guide plate 100 has a bottom surface 102 forming grid dots 300 that have a reflection face 302 parallel to the bottom surface 102 of the light guide plate 100. A light source 500 is set at one side of the light guide plate 100 and emits light toward the reflection faces 302 of the grid dots 300 where total reflection occurs to be projected out through an emergence surface 304 of the light guide plate 100. The light so projected does not show a spatial distribution that is symmetric about a normal direction of the light guide plate 100. The direction where the light shows the maximum energy is not in the normal direction of the light guide plate 100 and is instead in a direction that forms a large included angle β with respect to the normal direction. Consequently, the utilization rate of light is low and a diffusion board must be additional provided on the light guide plate 100 to correct the direction of the emerging light for making the maximum energy direction of the light parallel to the normal direction of the light guide plate 100.

### SUMMARY OF THE INVENTION

An object of the present invention is to provide a light guide plate, which has a bottom surface forming grid dots in such a way to have energy of emerging light mostly concentrated in the normal direction of the light guide plate to thereby improve utilization rate of light.

Another object of the present invention is to provide a backlight module, which has a simple structure, high light intensity, and excellent homogeneity of illumination.

To achieve the above objects, the present invention provides a light guide plate, which comprises a bottom surface, a top surface arranged opposite to the bottom surface, and a plurality of lateral surfaces arranged between the bottom surface and the top surface. One of the lateral surfaces forms a light incidence surface. The bottom surface forms a plurality of grid dots having a cross-section that is right angular. The grid dots are formed by recessing the bottom surface of the light guide plate toward the top surface. The grid dots each have an inclined face opposing the light incidence surface. The inclined face is arranged to get away from the light incidence surface by extending upward from the bottom surface.

The inclined faces of the grid dots form an included angle with respect to the bottom surface of the light guide plate. The included angle is between 40°-50°.

The grid dots are formed on the bottom surface of the light guide plate through stamping or engraving.

The grid dots have a straight face that is distant from the light incidence surface. The straight face is perpendicular to bottom surface.

The present invention also provides a backlight module, which comprises a backplane, a light guide plate arranged inside the backplane, and a backlight source arranged inside the backplane. The light guide plate comprises a bottom surface, a top surface arranged opposite to the bottom surface, and a plurality of lateral surfaces arranged between the bottom surface and the top surface. One of the lateral surfaces forms a light incidence surface. The bottom surface forms a plurality of grid dots having a cross-section that is right angular. The grid dots are formed by recessing the bottom surface of the light guide plate toward the top surface. The grid dots each have an inclined face opposing the light incidence surface. The inclined face is arranged to get away from the light incidence surface by extending upward from the bottom surface.

The inclined faces of the grid dots form an included angle with respect to the bottom surface of the light guide plate. The included angle is between 40°-50°.

The grid dots are formed on the bottom surface of the light guide plate through stamping or engraving.

The grid dots have a straight face that is distant from the light incidence surface. The straight face is perpendicular to bottom surface.

The backplane comprises a bottom board and plurality of side boards connected to the bottom board. The backlight source is mounted to the side boards of the backplane to correspond to the light incidence surface of the light guide plate. The backlight source and the side boards comprise a heat dissipation board arranged therebetween. The backlight source is attached to the heat dissipation board by heat dissipation paste. The heat dissipation board is mounted to the side boards through screwing or adhesives. The backlight source comprises a linear LED light bar.

The backlight module further comprises a reflector plate arranged between the bottom board of the backplane and the bottom surface of the light guide plate and an optic film assembly arranged on the top surface of the light guide plate.

The present invention further provides a light guide plate, which comprises a bottom surface, a top surface arranged opposite to the bottom surface, and a plurality of lateral surfaces arranged between the bottom surface and the top surface, one of the lateral surfaces forming a light incidence surface, the bottom surface forming a plurality of grid dots having a cross-section that is right angular, the grid dots being formed by recessing the bottom surface of the light guide plate toward the top surface, the grid dots having an inclined face opposing the light incidence surface, the inclined face being arranged to get away from the light incidence surface by extending upward from the bottom surface;

wherein the inclined faces of the grid dots form an included angle with respect to the bottom surface of the light guide plate, the included angle being between 40°-50°;

wherein the grid dots are formed on the bottom surface of the light guide plate through stamping or engraving; and

wherein the grid dots have a straight face that is distant from the light incidence surface, the straight face being perpendicular to bottom surface.

The efficacy of the present invention is that the present invention provides a light guide plate and a backlight module using the light guide plate, wherein recessed grid dots that are of right-angular shape are formed in the bottom surface of the light guide plate so that light emitting from a backlight source enters the light guide plate through a light incidence surface of the light guide plate and is reflected by the grid dots to emerges through a light emerging surface of the light guide plate, whereby energy of the light is mostly concentrated in a normal direction of the light guide plate to effectively improve utilization rate of light.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of one or more embodiments of the present invention, with reference to the attached drawings. In the drawings:

FIG. 1 is a schematic view showing light propagation in a conventional light guide plate;

FIG. 2 is a schematic view showing energy distribution of emerging light of the conventional light guide plate;

FIG. 3 is a schematic view showing light propagation in a light guide plate according to an embodiment of the present invention;

FIG. 4 is a schematic view showing energy distribution of emerging light of the light guide plate according to the present invention; and

FIG. 5 is a schematic view showing the structure of a backlight module according to the present invention.

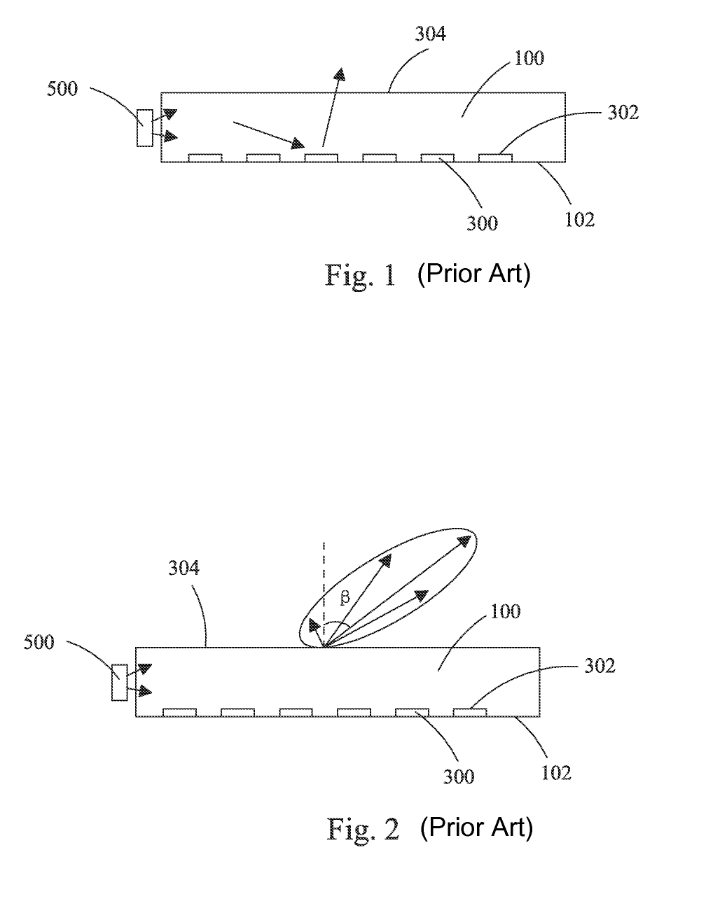

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

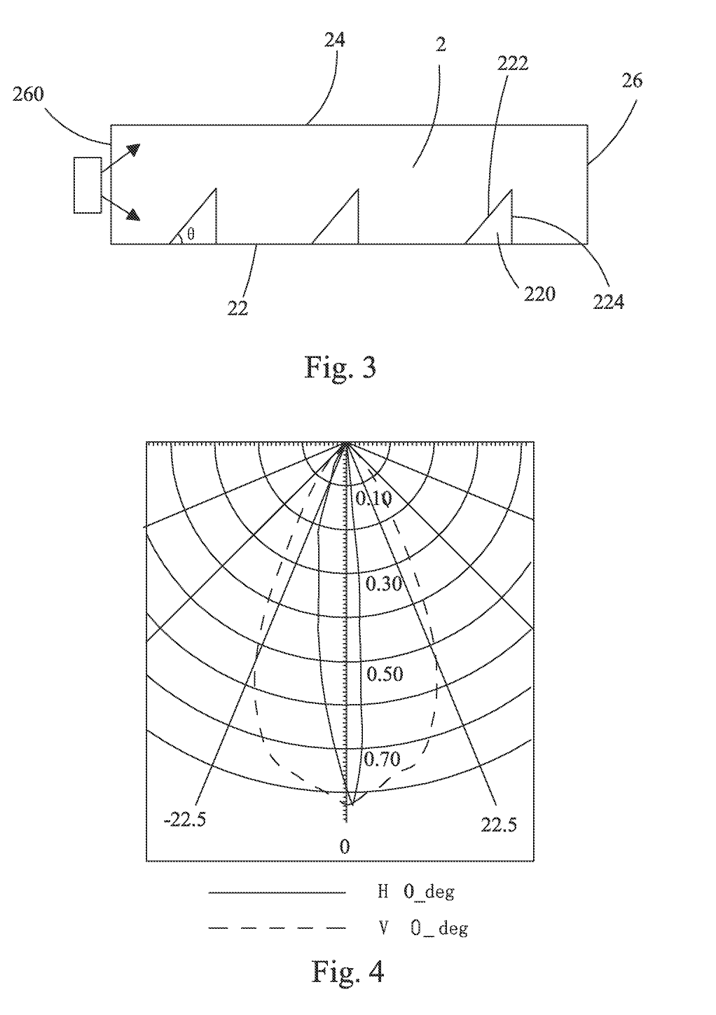

Referring to FIGS. 3 and 4, the present invention provides a light guide plate 2, which comprises a bottom surface 22, a top surface 24 arranged opposite to the bottom surface 22, and a plurality of lateral surfaces 26 arranged between the bottom surface 22 and the top surface 24. One of the lateral surfaces 26 forms a light incidence surface 260.

The bottom surface 22 forms a plurality of grid dots 220 having a cross-section that is right angular. The grid dots are formed by recessing the bottom surface 22 of the light guide plate 2 toward the top surface 24. Preferably, the grid dots 220 are formed on the bottom surface 22 of the light guide plate 2 through stamping or engraving.

The grid dots 220 have an inclined face 222 opposing the light incidence surface 260. The inclined face 222 is arranged to get away from the light incidence surface 260 by extending upward from the bottom surface 22. The inclined faces 222 of the grid dots 220 form an included angle θ with respect to the bottom surface 22 of the light guide plate 2. Preferably, the included angle θ ranges between 40°-50°.

The grid dots 220 also have a straight face 224 that is distant from the light incidence surface 260. The straight face 224 is perpendicular to bottom surface 22.

Light, when entering the light guide plate 2 through the light incidence surface 260, is reflected by the inclined faces 222 of the grid dots 220 to emerge from the top surface 24 of the light guide plate 2, whereby energy of the light is mostly concentrated in the normal direction of the light guide plate 2 so as to improve the utilization rate of light.

Referring to FIG. 4, a view is given to show distribution of energy of the emerging light from the light guide plate. It can be seen from FIG. 4 that the energy of the light emitting from the light guide plate 2 of the present invention is mostly concentrated in the normal direction of the light guide plate 2 so as to improve the utilization rate of light.

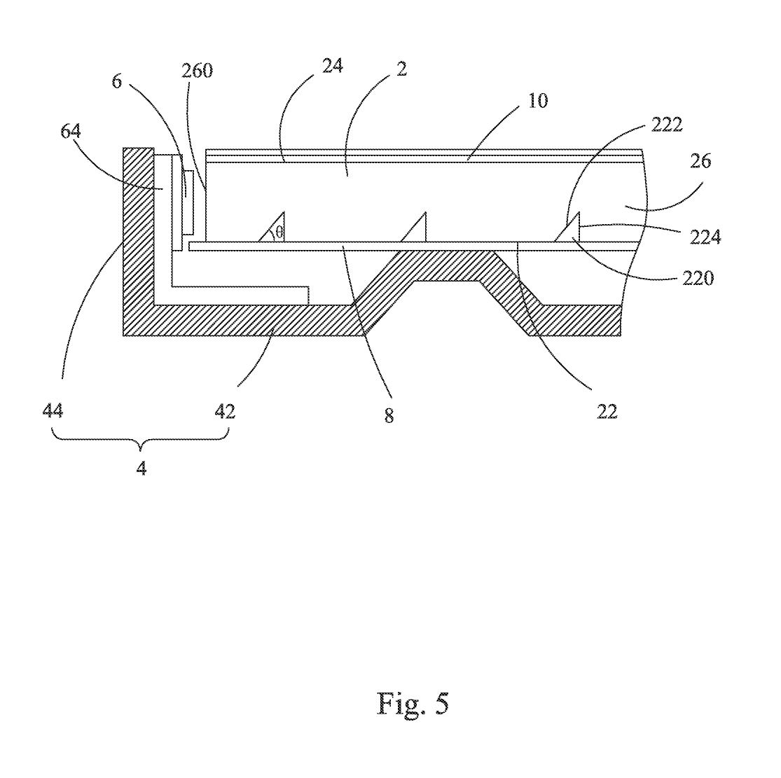

Referring to FIGS. 3-5, the present invention also provides a backlight module, which comprises a backplane 4, a light guide plate 2 arranged inside the backplane 4, and a backlight source 6 arranged inside the backplane 4.

The light guide plate 2 comprises a bottom surface 22, a top surface 24 arranged opposite to the bottom surface 22, and a plurality of lateral surfaces 26 arranged between the bottom surface 22 and the top surface 24. One of the lateral surfaces 26 forms a light incidence surface 260.

The bottom surface 22 forms a plurality of grid dots 220 having a cross-section that is right angular. The grid dots 220 are formed by recessing the bottom surface 22 of the light guide plate 2 toward the top surface 24. Preferably, the grid dots 220 are formed on the bottom surface 22 of the light guide plate 2 through stamping or engraving.

The grid dots 220 have an inclined face 222 opposing the light incidence surface 260. The inclined face 222 is arranged to get away from the light incidence surface 260 by extending upward from the bottom surface 22. The inclined faces 222 of the grid dots 220 form an included angle θ with respect to the bottom surface 22 of the light guide plate 2. Preferably, the included angle θ ranges between 40°-50°.

The grid dots 220 also have a straight face 224 that is distant from the light incidence surface 260. The straight face 224 is perpendicular to bottom surface 22.

The backlight source 6 comprises a linear LED light bar, which emits light that enters the light guide plate 2 through the light incidence surface 260 and is reflected by the inclined faces 222 of the grid dots 220 to emerge from the top surface 24 of the light guide plate 2, whereby energy of the light is mostly concentrated in the normal direction of the light guide plate 2 so as to improve the utilization rate of light.

The backplane 4 comprises a bottom board 42 and a plurality of side boards 44 connected to the bottom board 42. The backlight source 6 is mounted to the side boards 44 of the backplane 4 to correspond to the light incidence surface 260 of the light guide plate 2. Preferably, the backlight source 6 and the side boards 44 comprise a heat dissipation board 64 arranged therebetween. The backlight source 6 is attached to the heat dissipation board 64 by heat dissipation paste (not shown). The heat dissipation board 64 is mounted to the side boards 44 of the backplane 4 through screwing or adhesives.

It is noted that the backlight module further comprises a reflector plate 8 arranged between the bottom board 42 of the backplane 4 and the bottom surface 22 of the light guide plate 2 and an optic film assembly 10 arranged on the top surface 24 of the light guide plate 2. The backlight source 6 emits light that directly enters or is reflected by the reflector plate 8 into the light guide plate 2 to form a planar light source of homogeneous illumination.

Referring to FIG. 4, a view is given to show distribution of energy of the emerging light from the light guide plate. It can be seen from FIG. 4 that the energy of the light emitting from the light guide plate 2 of the present invention is mostly concentrated in the normal direction of the light guide plate 2 so as to improve the utilization rate of light.

In summary, the present invention provides a light guide plate and a backlight module using the light guide plate, wherein recessed grid dots that are of right-angular shape are formed in the bottom surface of the light guide plate so that light emitting from a backlight source enters the light guide plate through a light incidence surface of the light guide plate and is reflected by the grid dots to emerges through a light emerging surface of the light guide plate, whereby energy of the light is mostly concentrated in a normal direction of the light guide plate to effectively improve utilization rate of light.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A light guide plate, comprising a bottom surface, a top surface arranged opposite to the bottom surface, and a plurality of lateral surfaces arranged between the bottom surface and the top surface, one of the lateral surfaces forming a light incidence surface, the bottom surface forming a plurality of grid dots having a cross-section that is right angular, the grid dots being formed by recessing the bottom surface of the light guide plate toward the top surface, the grid dots having an inclined face opposing the light incidence surface, the inclined face being arranged to get away from the light incidence surface by extending upward from the bottom surface.

2. The light guide plate as claimed in claim 1, wherein the inclined faces of the grid dots form an included angle with respect to the bottom surface of the light guide plate, the included angle being between 40°-50°.

3. The light guide plate as claimed in claim 1, wherein the grid dots are formed on the bottom surface of the light guide plate through stamping or engraving.

4. The light guide plate as claimed in claim 1, wherein the grid dots have a straight face that is distant from the light incidence surface, the straight face being perpendicular to bottom surface.

5. A backlight module, comprising a backplane, a light guide plate arranged inside the backplane, and a backlight source arranged inside the backplane, the light guide plate comprising a bottom surface, a top surface arranged opposite to the bottom surface, and a plurality of lateral surfaces arranged between the bottom surface and the top surface, one of the lateral surfaces forming a light incidence surface, the bottom surface forming a plurality of grid dots having a cross-section that is right angular, the grid dots being formed by recessing the bottom surface of the light guide plate toward the top surface, the grid dots having an inclined face opposing the light incidence surface, the inclined face being arranged to get away from the light incidence surface by extending upward from the bottom surface.

6. The backlight module as claimed in claim 5, wherein the inclined faces of the grid dots form an included angle with respect to the bottom surface of the light guide plate, the included angle being between 40°-50°.

7. The backlight module as claimed in claim 5, wherein the grid dots are formed on the bottom surface of the light guide plate through stamping or engraving.

8. The backlight module as claimed in claim 5, wherein the grid dots have a straight face that is distant from the light incidence surface, the straight face being perpendicular to bottom surface.

9. The backlight module as claimed in claim 5, wherein the backplane comprises a bottom board and plurality of side boards connected to the bottom board, the backlight source being mounted to the side boards of the backplane to correspond to the light incidence surface of the light guide plate, the backlight source and the side boards comprising a heat dissipation board arranged therebetween, the backlight source being attached to the heat dissipation board by heat dissipation paste, the heat dissipation board being mounted to the side boards through screwing or adhesives, the backlight source comprising a linear LED light bar.

10. The backlight module as claimed in claim 9 further comprising a reflector plate arranged between the bottom board of the backplane and the bottom surface of the light guide plate and an optic film assembly arranged on the top surface of the light guide plate.

11. A light guide plate, comprising a bottom surface, a top surface arranged opposite to the bottom surface, and a plurality of lateral surfaces arranged between the bottom surface and the top surface, one of the lateral surfaces forming a light incidence surface, the bottom surface forming a plurality of grid dots having a cross-section that is right angular, the grid dots being formed by recessing the bottom surface of the light guide plate toward the top surface, the grid dots having an inclined face opposing the light incidence surface, the inclined face being arranged to get away from the light incidence surface by extending upward from the bottom surface;
wherein the inclined faces of the grid dots form an included angle with respect to the bottom surface of the light guide plate, the included angle being between 40°-50°;
wherein the grid dots are formed on the bottom surface of the light guide plate through stamping or engraving; and
wherein the grid dots have a straight face that is distant from the light incidence surface, the straight face being perpendicular to bottom surface.
